(19) United States
(12) Patent Application Publication
(10) Pub. No.: US 2024/0273653 A1
(43) Pub. Date: Aug. 15, 2024

(54) Smart Restaurant powered by Cloud-Native IoT AIOS with fully automated Contactless Food Preparation, Ordering & Vending

(71) Applicant: ILAKKUVASELVI MANOHARAN, AURORA, IL (US)

(72) Inventor: ILAKKUVASELVI MANOHARAN, AURORA, IL (US)

(21) Appl. No.: 18/110,099

(22) Filed: Feb. 15, 2023

Related U.S. Application Data
(60) Provisional application No. 63/484,931, filed on Feb. 14, 2023.

(51) Int. Cl. G06Q 50/12; B60W 60/00; G16Y 40/10; G16Y 40/30

(52) U.S. Cl. CPC G06Q 50/12; B60W 60/00256; G16Y 40/10; G16Y 40/30

(57) ABSTRACT

The present invention is a fully automated, AI-based smart restaurant system that leverages the power of Cloud Native IoT AIOS to revolutionize the food service industry. This system integrates IoT appliances within the kitchen to create a connected and intelligent ecosystem that optimizes food preparation processes and guarantees consistent quality. The AIOS fully automates all kitchen tasks and processes, including ordering, ingredient tracking, and inventory management, resulting in maximum efficiency and minimal resource consumption. With the AIOS running the show, there is no need for manual labor, making the restaurant a completely contactless experience. The AIOS monitors and regulates food preparation processes to minimize the risk of food contamination and other health hazards, ensuring a safe dining experience for customers. The AIOS also collects and analyzes real-time data, allowing for continuous improvement and optimization of the kitchen's processes, making the smart restaurant system a game-changer for the food service industry.

### BACKGROUND OF THE INVENTION

The food service industry is continuously seeking ways to improve the efficiency, safety, and convenience of food preparation and delivery. The present invention introduces a fully automated, AI-based smart restaurant system that leverages the power of Cloud Native IoT AIOS. This system integrates IoT appliances within the kitchen to create a connected and intelligent ecosystem that optimizes food preparation processes.

The Cloud Native IoT AIOS is designed to benefit the food service industry in several ways. Firstly, it enables real-time monitoring and control of the kitchen's processes, reducing the risk of food contamination and other health hazards. Secondly, the AIOS leverages advanced algorithms and machine learning techniques to optimize food preparation processes, ensuring consistent quality and reducing waste.

Additionally, the Cloud Native IoT AIOS automates various kitchen tasks and processes, such as food preparation, ordering, ingredient tracking, and inventory management, resulting in increased efficiency and reduced resource consumption. The AIOS can also collect and analyze data in real-time, allowing for continuous improvement and optimization of the kitchen processes. For example, the AIOS can track customer ordering patterns and make recommendations for menu changes or ingredient sourcing based on this data.

The Cloud Native IoT AIOS can also monitor the performance of kitchen appliances and predict when maintenance is required, reducing downtime and increasing the efficiency of the kitchen. The integration of IoT appliances within the kitchen enables the AIOS to control and regulate various processes, resulting in a more streamlined and efficient food preparation experience.

In conclusion, the integration of Cloud Native IoT AIOS into the food service industry brings numerous benefits, including increased efficiency, consistent quality, reduced waste and an improved customer experience with 24/7 availability.

### FIELD OF THE INVENTION

The field of the above invention is food service technology and automation. It is a subfield of the broader categories of robotics and artificial intelligence, which focus on the development of advanced systems and algorithms for automating various tasks and processes. The invention specifically relates to the application of these technologies in the food service industry, with a focus on improving the efficiency, consistency, and safety of food preparation and delivery.

### SUMMARY OF THE INVENTION

The present invention is a fully automated, AI-based smart restaurant system that leverages the power of Cloud Native IoT AIOS to revolutionize the food service industry. This system integrates IoT appliances within the kitchen to create a connected and intelligent ecosystem that optimizes food preparation processes and guarantees consistent quality. The AIOS fully automates all kitchen tasks and processes, including ordering, ingredient tracking, and inventory management, resulting in maximum efficiency and minimal resource consumption. With the AIOS running the show, there is no need for manual labor, making the restaurant a completely contactless experience. The AIOS monitors and regulates food preparation processes to minimize the risk of food contamination and other health hazards, ensuring a safe dining experience for customers. The AIOS also collects and analyzes real-time data, allowing for continuous improvement and optimization of the kitchen's processes, making the smart restaurant system a game-changer for the food service industry.

### DETAILED DESCRIPTION OF THE INVENTION

This invention provides a system for Cloud Native AIOS IoT Smart Restaurant with Smart Kitchen for Contactless Food Preparation, Ordering & Vending. The essential parts of the AIOS IoT Smart Restaurant comprises the Smart Kitchen, the Chef's App, the Smart Restaurant Cloud Native IoT AIOS, the Ordering System, the Vending System, and the Security System. The Smart Restaurant OS is AI based, which helps in optimization of food preparation, improved efficiency, improved consistency, cost savings, enhanced safety, increased capacity and reduction in food waste.

### The Smart Restaurant:

FIG. 1 illustrates a high level block diagram of an example Smart Restaurant 100. The essential parts of the AIOS IoT Smart Restaurant comprises the Smart Kitchen 101, the Chef's App 102, the Smart Restaurant Cloud Native IoT AIOS 103, the Ordering System 104, the Vending System 105, and the Security System. The Smart Restaurant further comprises the Smart Garden 111 where plants are grown, processed and transported to storage without human intervention. The Smart Garden is located on the top floor of the restaurant.

### The Smart Kitchen:

The Smart Kitchen comprises the Base Transport System 106 wherein the Base Transport System covers the floor of the Smart Kitchen enough to accommodate the available IoT kitchen appliance(s) and IoT system(s). All of the Smart Kitchen appliance(s) for food preparation and packaging are mounted on top of the Base Transport System 106. The Base Transport System connects to the Storage System 108 and the Ready To Vend System 107.

FIG. 2 illustrates an example Smart Kitchen comprising the Base Transport System wherein the Base Transport System comprising the pathways through which the “cars” containing the packaged food travel and carry the food from source to the destination. The Smart Kitchen further comprises IoT kitchen appliances, the Temperature Controlled IoT Storage System & Freezers and the Ready To Vend System.

The Smart Kitchen can comprise zero or more IoT Pizza Dough Prep Stack(s), zero or more IoT Pizza Crust Prep Stack(s), zero or more Pizza Maker Stack(s), zero or more IoT Fruits Cutter Stack(s), zero or more IoT Juice Maker Stack(s), zero or more Pancake Stack(s), zero or more Baking Oven(s), zero or more Cake Stack(s), zero or more Pasta Dough Prep Stack(s), zero or more Pasta Maker Stack(s), zero or more Vegetable Cutter Stack(s), zero or more Sauce Maker Stack(s). The number and type of IoT kitchen appliances included in the system can be customized according to the Smart Restaurant owner's needs and preferences.

FIG. 3 illustrates an example Smart Kitchen 101 wherein the Smart Kitchen 101 comprising the Pizza Dough Prep Stack 301, Pizza Crust Prep Stack 302 and Pizza Maker Stack 310 mounted on the Base Transport System 106. The Pizza Dough Prep Stack 301 comprises Pizza Dough Station 303, Pizza Dough Packager 304, Pizza Dough Maker 305 and Lifts 309. The Pizza Crust Prep Stack 302 comprises Pizza Crust Station 306, Pizza Crust Packager 307, Pizza Crust Maker 308 and Lifts 309. The Pizza Maker Stack 310 comprises Pizza Station 311, Pizza Packager 312, Pizza Maker 313, Toppings Dispenser 314 and Lifts 309.

FIG. 4 illustrates an example Smart Kitchen 101 wherein the Smart Kitchen 101 comprising the Fruit Slicer Stack 401, Juice Stack 405 and Pancake Stack 409 mounted on the Base Transport System 106. The Fruit Slicer Stack 401 comprises Fruit Slicer Station 402, Fruit Slice Packager 403, Fruit Slicer 404 and Lifts 309. The Juice Stack 405 comprises Juice Station 406, Juice Packager 407, Juice Maker 408 and Lifts 309. The Pancake Stack 409 comprises Pancake Station 410, Pancake Packager 411, Pancake Maker 412 and Lifts 309.

### The Chef's App:

The Chef's App is a standalone app for an iPad-like device that communicates with the Cloud-Native IoT AI Operating Systems (AIOS) and has a user interface. The Chef's App is an user interface through which the operator of the restaurant can interact with the Cloud Native IoT AIOS (Artificial Intelligence based Operating System) of the Smart Restaurant to control and monitor the Smart Restaurant.

The Chef's App can be used to send requests to the Smart Restaurant Cloud Native IoT AIOS to control the operations and monitor the various systems and components of Smart Restaurant for contactless food preparation, ordering and vending, schedule the processes in the Smart Restaurant, access the data and reports generated by the AIOS or request to generate reports for the given specifications, to use the emergency control to turn off the smart restaurant or a part(s) of it, turn on and off the restaurant or part(s) of it as needed.

The Chef's App can further be used to send requests to the Smart Restaurant Cloud Native IoT AIOS to run diagnostics reports, turn the Smart Restaurant or part(s) of it into maintenance mode or schedule a maintenance wherein the Smart Restaurant run diagnostics, cleans and repairs itself and sends reports on areas requiring attention from the operator.

### Basic Embodiment

The Chef's App communicates with the Smart Kitchen AIOS (Artificial Intelligence Operating System) through APIs (Application Programming Interfaces). An API allows the Chef's App to send requests to AIOS, receive data in response, and perform actions accordingly. The communication between the Chef's App and AIOS can be facilitated through RESTful APIs, which use standard HTTP methods like GET, POST, PUT, and DELETE to exchange data between the two systems. In order for the mobile app to access AIOS's APIs, it needs to obtain an API key or other form of authentication.

### Preferred Embodiment

The Chef's App communicates with the Smart Kitchen AIOS using a distributed streaming platform like Kafka. The Chef's App acts as a Kafka producer, which sends data to the AIOS through a Kafka topic. The Chef's App packages the data it wants to send into messages and publishes them to the topic. Kafka has a cluster of brokers that receive the messages from the producer and store them in a distributed fashion. The brokers ensure that the messages are delivered to the intended recipient. The AIOS acts as a Kafka consumer, which receives the messages from the broker and processes them. The AIOS subscribes to the topic to which the Chef's App is publishing messages and retrieves the messages from the broker. The AIOS processes the messages received from the Chef's App and generates the response. The AIOS can also send messages back to the Chef's App through another topic, which the Chef's App can subscribe to and receive the response.

### Most Preferred Embodiment

The Chef's App communicates with the Smart Restaurant Cloud Native IoT AIOS using MQTT (Message Queuing Telemetry Transport). MQTT is a lightweight messaging protocol designed for IoT devices and cloud-based architectures, making it a popular choice for IoT communications. In an MQTT-based architecture, the Chef's App would act as a client and the AIOS would act as a broker. The Chef's App can subscribe to specific topics on the broker to receive data and publish messages to the broker to send data to the AIOS. MQTT supports both QoS (Quality of Service) levels and secure communication through the use of SSL/TLS encryption.

### The Smart Restaurant AIOS:

The Smart Restaurant AIOS is a software system that integrates various technologies such as machine learning, natural language processing, computer vision, and others to automate and optimize various functions in a restaurant. The aim of a smart restaurant AIOS is to improve the customer experience, increase operational efficiency, and enhance revenue generation for the restaurant.

The Smart Restaurant AIOS provides an intelligent and efficient solution to manage. day-to-day operations of the Smart Kitchen such as food preparation, ordering/POS(point of sale) and vending. Additionally, it can also help with menu recommendations, inventory management, and financial analysis.

### Preferred Embodiment

The Smart Restaurant AIOS can further be Cloud native which refers to an AIOS architecture that is designed specifically to run on cloud computing platforms. This type of AIOS is optimized for the cloud environment and leverages the benefits of the cloud, such as scalability, availability, and security. It also enables AIOS to take advantage of the cloud's inherent flexibility, which allows for rapid and efficient deployment and management of AIOS-powered applications and services. Cloud native AIOS can also be easily integrated with other cloud-based services, such as databases, storage systems, and analytics tools, to form a complete and cohesive cloud-based AI ecosystem.

### Most Preferred Embodiment

The Smart Restaurant AIOS can be implemented as a Cloud-Native IoT AI Operating Systems (AIOS). Cloud-Native IoT AI Operating Systems (AIOS) are operating systems specifically designed for IoT devices to support and optimize the deployment of artificial intelligence (AI) and machine learning (ML) workloads in cloud computing environments. These operating systems are designed to be resource-efficient and lightweight, yet capable of handling complex AI and ML algorithms, to enable low-power, edge devices to run AI and ML workloads locally. Some examples of cloud-native IoT AIOS are:
AWS Greengrass: An IoT edge computing platform that enables IoT devices to run local AI and ML workloads and securely communicate with cloud services.
Microsoft Azure IoT Edge: An IoT edge computing platform that enables IoT devices to run local AI and ML workloads and securely communicate with cloud services.
Google Edge TPU: A custom-built ASIC designed to run AI workloads at the edge, and a software stack for deployment in Google Cloud IoT environments.
Nvidia Jetson: A platform for building AI and robotics applications, powered by Nvidia GPUs, and optimized for deployment on IoT devices.

These cloud-native IoT AIOS allow for AI and ML workloads to be executed locally on IoT devices, reducing the amount of data that needs to be sent to the cloud and providing low-latency, real-time AI processing capabilities for IoT applications.

Cloud-Native IoT AI Operating Systems (AIOS) connected to IoT kitchen appliances allow for these appliances to run AI and machine learning (ML) algorithms locally and securely communicate with cloud services for data storage, analysis, and further processing. This allows for intelligent and efficient kitchen appliances that can self-optimize and improve over time based on usage data and user preferences.

For example, a cloud-native IoT AIOS connected to a smart oven can use ML algorithms to learn cooking patterns and preferences, and suggest cooking times and temperatures based on the type of food being cooked. The oven can also send data to the cloud for analysis, such as energy consumption data, to improve energy efficiency and help reduce waste.

Another example is a cloud-native IoT AIOS connected to a smart refrigerator, which can use computer vision and ML algorithms to recognize the contents of the fridge and suggest recipes based on the ingredients on hand. The refrigerator can also send data to the cloud for analysis, such as food expiration dates and consumption patterns, to help reduce food waste.

These cloud-native IoT AIOS provide a secure and efficient platform for developing and deploying AI and ML algorithms in IoT kitchen appliances and systems, enabling new and innovative experiences and applications in the connected kitchen.

The kitchen appliances (e.g. smart ovens, smart refrigerators, smart storage systems and freezers, pizza dough makers, etc.) and other systems such as the Security System, Ready to Vend System, Base Transport System, Ordering and Vending Systems of the Smart Restaurant which are IoT devices are equipped with sensors, cameras, and other relevant peripherals for collecting data. IoT gateways or edge devices (e.g. Raspberry Pi, NVIDIA Jetson, etc.) serve as the interface between the IoT devices and the cloud. These edge devices are typically equipped with powerful processors and GPUs that enable them to run AI and ML algorithms locally.

Running AI and ML algorithms locally on IoT gateways or edge devices has the following advantages and disadvantages:

### Advantages:

Lower latency: By processing data locally, edge devices can make real-time decisions based on the data they receive from IoT devices, which can improve the overall responsiveness and performance of the system.
Reduced network bandwidth: By processing data locally, the amount of data that needs to be transmitted over the network is reduced, which can help to reduce network bandwidth requirements.
Increased security: Sensitive data can be processed and stored locally rather than being transmitted over the network, which can help to increase the security of the system.

### Disadvantages:

Limited processing resources: IoT gateways or edge devices may have limited processing resources, which can limit the complexity of the algorithms they can run.
Maintenance overhead: Maintaining and upgrading the software and hardware on edge devices can be more challenging than managing resources in the cloud.

It is also possible to run AI and ML algorithms in the cloud-native IoT AIOS which has its own advantages and disadvantages:

### Advantages:

Scalability: The cloud can provide an almost unlimited amount of processing power and storage, which can be scaled up and down as needed to meet the demands of the system.
Maintenance overhead: Maintaining and upgrading the resources in the cloud can be easier than maintaining and upgrading edge devices.
Access to advanced algorithms: By running algorithms in the cloud, users have access to a wider range of advanced algorithms and libraries, which can provide more accurate and sophisticated results.

### Disadvantages:

Latency: Running algorithms in the cloud can result in increased latency, as data needs to be transmitted over the network before it can be processed.
Network bandwidth requirements: Running algorithms in the cloud can result in increased network bandwidth requirements, as more data needs to be transmitted over the network.
Security concerns: Storing and processing sensitive data in the cloud can raise security concerns, as data is transmitted over the network and stored on third-party servers.

Communication between the Smart Restaurant systems, the Smart Kitchen IoT kitchen appliances and the Cloud-Native IoT AIOS:

The Smart Restaurant systems such as the Smart Kitchen, the Ordering and the Vending Systems, the Security Systems, the Smart Garden and all the kitchen appliances and the systems of the Smart Kitchen are connected IoT devices.

The communication between the Smart Restaurant Cloud-Native IoT AI Operating System (AIOS) and the Smart Restaurant systems, the Smart Kitchen IoT kitchen appliances enables real-time control and monitoring of the connected IoT devices, allowing the operator to control and manage the Smart Restaurant operations and functions, schedule tasks, monitor performance and take actions as needed.

The communication between Cloud Native IoT AIOS and connected IoT devices can be achieved through various protocols such as MQTT, HTTP, CoAP, and Web Sockets. These protocols enable bidirectional communication between the AIOS and IoT devices, allowing the exchange of data and messages in real-time. The choice of protocol would depend on various factors such as network constraints, security requirements, and the type of data being exchanged. The AIOS may use a message broker such as Apache Kafka to manage the communication and ensure reliable delivery of messages. Additionally, encryption and authentication techniques can be employed to secure the communication between the AIOS and IoT devices.

Basic Embodiment: The communication can be established using various secure wireless communication protocols, including Wi-Fi, Zigbee, Bluetooth Low Energy (BLE), or Ethernet, depending on the specific requirements of the restaurant.

Most Preferred Embodiment: An IoT gateway is used to facilitate the communication between the AIOS and the Smart Kitchen systems and appliances. The IoT gateway acts as a bridge between the two systems, translating commands from the AIOS into a format that the Smart Restaurant connected IoT systems can understand and vice versa. The IoT gateway can enable interoperability between IoT devices that use different protocols, and ensure that the data can be transmitted securely and reliably to the AIOS. The IoT gateway also provides added security and reliability to the communication, enforcing security policies and access controls, and ensuring the privacy of sensitive information.

The use of secure communication protocols and an IoT gateway allows for seamless control and monitoring of the kitchen appliance, improving the efficiency and functionality of the smart restaurant. The real-time communication between the AIOS and the smart kitchen ensures that the scheduling instructions are executed precisely as intended and enables the smart kitchen to operate autonomously.

IoT communication protocols (MQTT, HTTP, CoAP, and Web Sockets) can be used for exchanging data and messages between IoT devices and the Cloud Native IoT AIOS.
MQTT (Message Queuing Telemetry Transport) is a lightweight, publish-subscribe based protocol optimized for IoT devices with limited processing power and bandwidth.
HTTP (Hypertext Transfer Protocol) is a widely used protocol for transmitting data over the web, but its overhead makes it less suitable for IoT applications with limited resources.
CoAP (Constrained Application Protocol) is a protocol designed for IoT devices that operate over IP networks, and it provides a simple, low-overhead alternative to HTTP.
Web Sockets is a protocol that enables bi-directional communication between a client (such as a web browser) and a server over a single connection, providing low latency, full-duplex communication suitable for real-time applications.

The best protocol for a smart restaurant with multiple connected smart kitchen appliances depends on the specific requirements and constraints of the application. It may be necessary to use a combination of protocols to meet the needs of all the appliances.

Every components in the Smart Restaurant including all the kitchen appliances, the Base Transport Systems, the Storage Systems, the Smart Garden are IoT devices comprising:
IoT Actuators and IoT Sensors,
a graphical user interface (GUI) where users can input their desired pizza toppings, cooking temperature, and cooking time. (The GUI is not used in the Smart Restaurant. The GUI is used only in testing the appliances or systems),
an Application Layer is responsible for processing and analyzing the data, communicating the processed data to the communication layer,
a Communication Layer which is responsible for transmitting data from the IoT device to the cloud-based IoT AIOS and vice versa. It uses IoT protocols like MQTT, CoAP, or HTTP to handle the communication between the application layer and the IoT devices.

The Application Layer comprises the Data processing and Analysis Block which is responsible for processing and analyzing the data collected by the IoT sensors and making decisions based on the data, the Data Communication Block which communicates the processed data to the communication layer for transmission to the cloud-based IoT AIOS, and the Command Execution Block which receives commands or instructions from the IoT AIOS, and then forwards them to the appropriate actuators or other components in the IoT device to carry out the desired actions.

The Communication Layer comprises the Data Transmission Block which is responsible for transmitting data from the IoT device to the cloud-based IoT AIOS and vice versa, the necessary IoT Protocols for secure and efficient communication between the IoT device and the IoT AIOS and Data Security Block the implements security measures such as encryption and authentication to protect the data transmitted between the IoT device and the IoT AIOS.

FIG. 5 illustrates the flow of communication between the IoT devices used in the Smart Restaurant and an example generic Cloud Native IoT AIOS.

IoT actuators in the IoT devices receive commands from the Cloud Native IoT AIOS using IoT protocols such as MQTT, CoAP, or HTTP. IoT sensors collect data and send it to the Cloud Native IoT AIOS using IoT protocols. The Cloud Native IoT AIOS processes the data and stores it in a data storage system such as a cloud database. The data stored in the data storage system can be used to train AI models. The trained models can be deployed in the IoT system for real-time decision-making. The processed data can be analyzed to gain insights and monitor the performance of the AI models. The specific services, protocols, and configurations used may vary depending on the specific requirements and use case.

Emergency switch for the Smart Restaurant:

The emergency switch in the Smart Restaurant serves as a backup mechanism to promptly shut down or activate the entire smart restaurant or individual kitchen appliances or systems in the event of an emergency. When the operator uses the Chef's App to trigger the switch, a request is sent to the Cloud-Native IoT AI Operating System (AIOS). The AIOS then responds by either turning off or on the entire restaurant or the designated kitchen appliances or systems, providing efficient control during unforeseen circumstances such as power outages or equipment malfunctions.

FIG. 6 illustrates a flow diagram showing the communication between the Chef's App, Cloud Native IoT AIOS and the Pizza Dough Prep Stack for scheduling the Pizza Dough Prep Stack to prepare pizza dough at specific times and intervals, and store it in the Storage System.

Every system or kitchen appliance within the Smart Kitchen comprises a station that incorporates one or more tiny automated vehicles, referred to as cars, to transport packages to designated destinations. The tiny automated vehicles, or cars, within the Smart Kitchen and Smart Restaurant travel on a Base Transport System. This Base Transport System provides a foundation for the cars to move and transport packages to their designated destinations. The Base Transport System is designed to work in conjunction with the station that incorporates the cars and the Smart Restaurant AIOS, which provides the commands for the cars' movement, monitors and controls the process of package transportation. The combination of the Base Transport System, the IoT stations, and the AI and IoT technology provides an integrated and efficient solution for package transportation within the Smart Kitchen and Smart Restaurant.

The invention also discloses an alternative embodiment where a common station is provided that incorporates tiny automated vehicles, referred to as cars, to transport packages to designated destinations. The cars are integrated into the common station and are utilized to optimize the process of package transportation within the Smart Kitchen and Smart Restaurant.

Here's a simple flow diagram of the communication between different systems when a customer orders a pizza at the drive through of the Smart Restaurant.
1. Customers order pizza using an ordering system and an order card with a barcode is printed out.
2. If the customer has input their mobile app account information or their mobile number during ordering and selects the option to receive the paperless order card in their mobile, a barcode is generated and sent to the customer's mobile.
3. Ordering system is integrated with the POS(Point of Sale) system and the payment processing system and sends the order details to the Cloud Native IoT AIOS
4. Cloud Native IoT AIOS communicates with the Pizza Stack to check if ingredients and resources are available to make the pizza.
5. Pizza Stack sends a confirmation to the Cloud Native IoT AIOS if resources are available.
6. Cloud Native IoT AIOS communicates with the Storage system to dispense the ingredients for the pizza.
7. Cloud Native IoT AIOS communicates with the Base Transport System to deliver the ingredients for the pizza to the Pizza Stack.
8. The ingredients for pizza toppings, cheese and sauce are delivered to the Toppings Sprayer in the Pizza Stack and the pizza crust is delivered to the Pizza Maker in the Pizza Stack. The ingredients travel up and down using the lifts on the sides of the Pizza Stack.
9. Pizza Maker starts making the pizza and sends updates to the Cloud Native IoT AIOS.
10. Cloud Native IoT AIOS controls and monitors the Pizza making process and the data is collected and stored in the cloud database.
11. Upon completion, the Pizza Stack sends a notification to the Cloud Native IoT AIOS.
12. After the Pizza is made and ready to be packaged, the pizza is moved or dropped to the Pizza Packager in the Pizza Stack.
13. When the pizza is packaged, the AIOS sends commands to the Pizza Station to check for the availability of the car.
14. When the car is available, Cloud Native IoT AIOS sends a notification to the base transport system to pick up the pizza and deliver it to the destination. In this case, the destination is the Ready To Vend System.
15. The car carrying the pizza package is controlled and moved by the AIOS which uses sensor and computer vision to avoid traffic at the Base Transport System and drive from the Pizza Station to the Ready to Vend System
16. Vending system updates the customer that their pizza is on its way.
17. When the customer is at the vending window and scans their order card with a barcode, the AIOS sends commands to the Ready To Vend System and the Vending System to deliver the customer's order at the vending window.

FIG. 7 illustrates an example block diagram for an AI IoT fruit slicer with computer vision. The input to the system is the fruit to be sliced, which is placed in front of the camera module. The camera module captures an image of the fruit. The image processing unit runs the computer vision algorithm to detect the fruit and its position in the image. The control unit receives the results of the computer vision algorithm and uses them to control the slicing mechanism. The slicing mechanism is responsible for slicing the fruit based on the control signals received from the control unit. The output of the system is the sliced fruit.

FIG. 8 illustrates an example block diagram for AI-based monitoring of IoT devices.
IoT Devices: These are the physical devices equipped with sensors that collect data from the environment.
Data Collection: The data collected by the IoT devices is sent to a data collection component, where it is processed and stored.
Data Preprocessing: The collected data is preprocessed to remove any noise or irrelevant information and to prepare it for analysis.
Feature Extraction: The preprocessed data is then processed to extract relevant features that can be used to train machine learning models.
Model Training: The extracted features are used to train machine learning models, such as supervised or unsupervised models, that can be used for monitoring purposes.
Model Deployment: The trained models are deployed on a hardware platform, such as an edge device or cloud-based platform, for real-time monitoring of IoT devices.
Real-time Monitoring: The deployed models are used to monitor the IoT devices in real-time, analyzing incoming data and detecting any anomalies or deviations from normal behavior.
Alert Generation: In case of any anomalies or deviations from normal behavior, the monitoring component generates an alert, which can be used to trigger appropriate actions.
Decision Making: The alerts generated by the monitoring component can be used by decision-making components, such as human operators or automated systems, to take appropriate actions.

FIG. 9 illustrates an example block diagram for AWS Implementation of IoT AIOS. In the AWS implementation of IoT AIOS, data from IoT devices is collected and transmitted to AWS IoT Core for secure communication with the cloud. From there, the data is transmitted to AWS Greengrass for edge computing, where it can be processed and analyzed before being transmitted to the cloud.

The data is then sent to AWS Lambda for processing and analysis, and it can also be stored in AWS S3, which provides scalable and secure storage for data. For machine learning tasks, the data can be used for training and deploying models using AWS SageMaker. The processed data can then be analyzed in real-time using AWS Kinesis Data Streams.

After the data has been processed and analyzed, it can be analyzed using Amazon Athena, a serverless, interactive query service that allows you to analyze data stored in S3 using standard SQL. With Amazon Athena, you can quickly and easily perform ad-hoc analysis on the data collected from your IoT devices.

After the data has been processed and analyzed using Amazon Athena, it can be visualized and presented to users in a variety of ways using Amazon QuickSight. Amazon QuickSight provides fast, cloud-powered business intelligence and visualization capabilities that make it easy to create interactive dashboards, reports, and visualizations that highlight key metrics and insights.

FIG. 10 illustrates an example block diagram for Google Cloud Implementation of IoT AIOS. In Google Cloud's implementation of IoT AIOS, data from IoT devices flows to Google Cloud IoT Core. Google Cloud IoT Core is a fully managed service that provides secure communication between IoT devices and the cloud. It allows for the management of devices, authentication, and access control, and it is the foundation for communication between the IoT devices and the rest of the Google Cloud services.

Once the data arrives at Google Cloud IoT Core, it is transmitted to Google Cloud Pub/Sub, which is a messaging service that provides real-time communication between IoT devices and the cloud. Google Cloud Pub/Sub acts as a messaging broker, allowing IoT devices to publish data and for other services to subscribe to the data for processing and analysis.

From there, the data can be processed and analyzed by other Google Cloud services, such as Google Cloud Functions, Google BigQuery, Google Cloud Machine Learning Engine, and Google Cloud Dataflow, to enable intelligent decision making based on the data from the IoT devices.

FIG. 11 illustrates an example block diagram for Azure Implementation of IoT AIOS. In this diagram, the IoT devices collect data which is transmitted to the cloud platform via Azure IoT Hub. The data is filtered and processed by Edge Devices using Azure IoT Edge and then transmitted to Azure Functions for further analysis. The data is stored in Azure Blob Storage and can be processed by Azure Stream Analytics.

Data analysis and visualization can be performed using Azure Synapse Analytics (formerly SQL Data Warehouse) and Power BI. Azure Event Grid is used to send alerts and notifications based on data analysis results, and Azure Monitor is used for monitoring and logging of the data and processing pipelines in the Azure environment.

### BRIEF DESCRIPTION OF THE DRAWINGS

FIG. 1 illustrates a high level block diagram of an example Smart Restaurant 100.

FIG. 2 illustrates an example Smart Kitchen 101 comprising the Base Transport System.

FIG. 3 illustrates an example Smart Kitchen comprising the Pizza Dough Prep Stack 301, Pizza Crust Prep Stack 302 and Pizza Maker Stack 310 mounted on the Base Transport System 106.

FIG. 4 illustrates an example Smart Kitchen 101 comprising the Fruit Slicer Stack 401, Juice Stack 405 and Pancake Stack 409 mounted on the Base Transport System 106.

FIG. 5 illustrates the flow of communication between the IoT devices used in the Smart Restaurant and an example generic Cloud Native IoT AIOS.

FIG. 6 illustrates a flow diagram showing the communication between the Chef's App, Cloud Native IoT AIOS and the Pizza Dough Prep Stack for scheduling the Pizza Dough Prep Stack to prepare pizza dough at specific times and intervals, and store it in the Storage System.

FIG. 7 illustrates an example block diagram for an AI IoT fruit slicer with computer vision.

FIG. 8 illustrates the block diagram for AI-based monitoring of IoT devices

FIG. 9 illustrates an example block diagram for AWS Implementation of IoT AIOS

FIG. 10 illustrates an example block diagram for Google Cloud Implementation of IoT AIOS

FIG. 11 illustrates an example block diagram for Azure Implementation of IoT AIOS

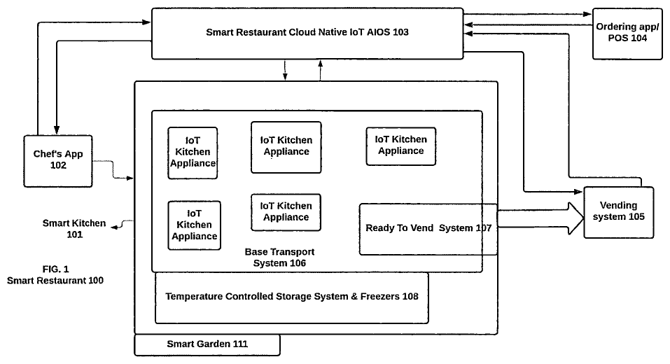

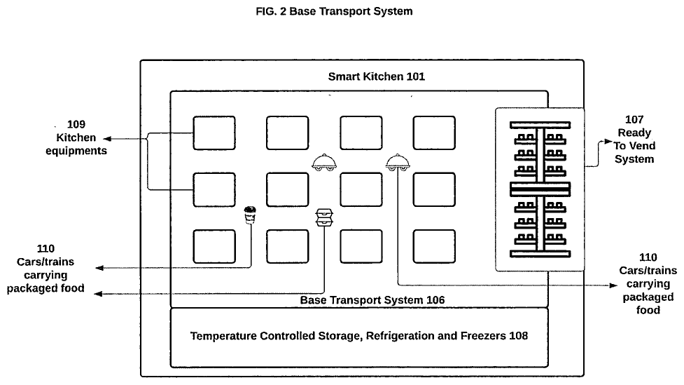

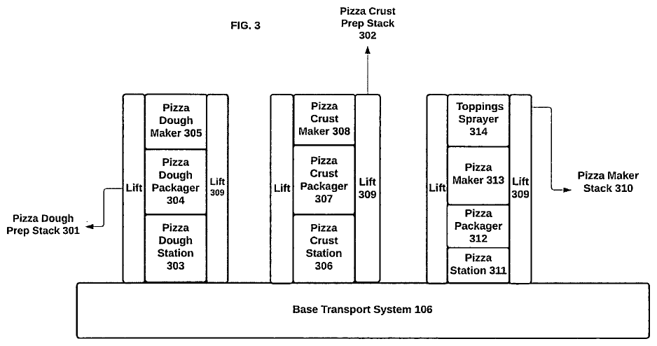

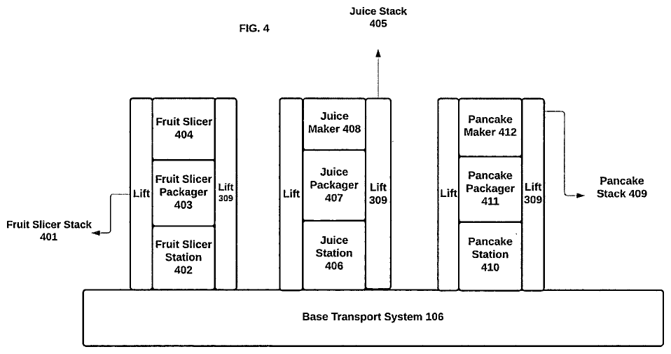

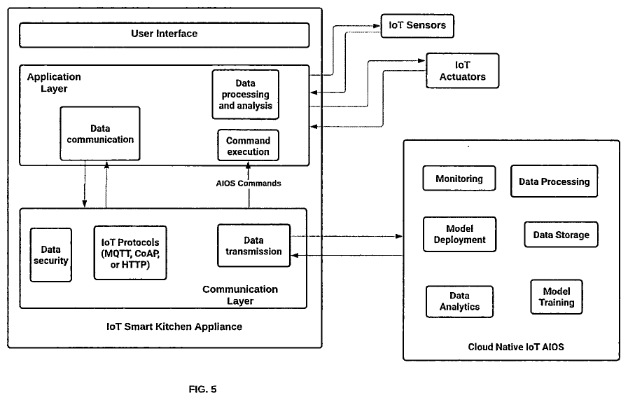

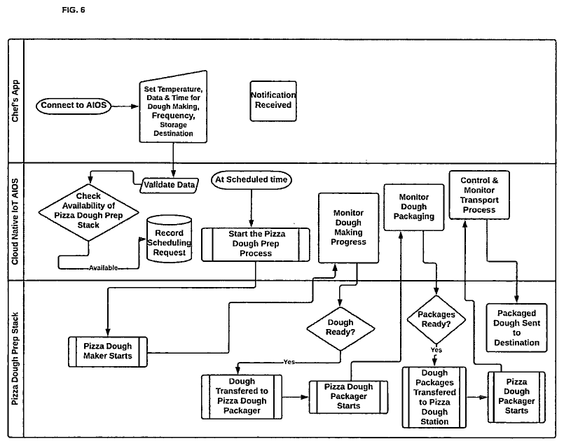

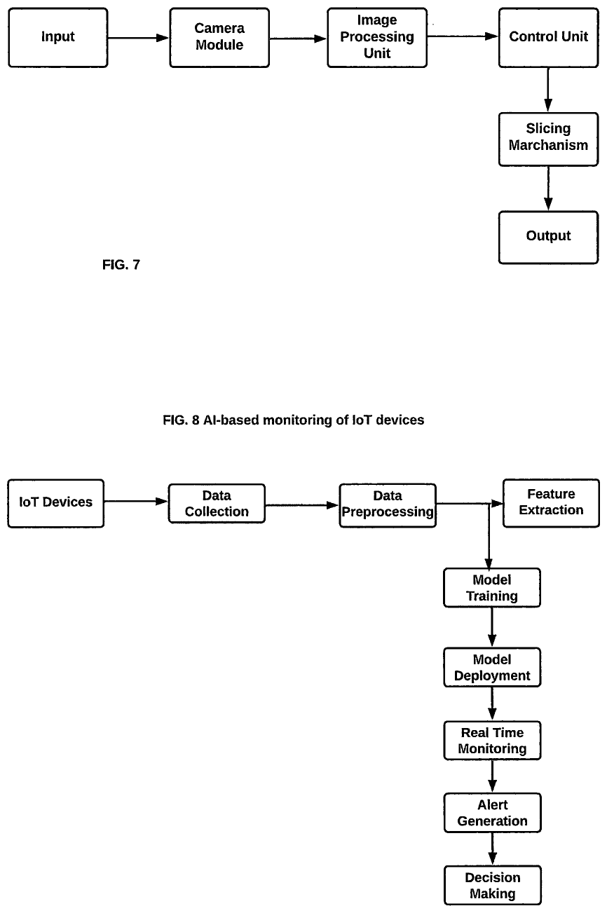

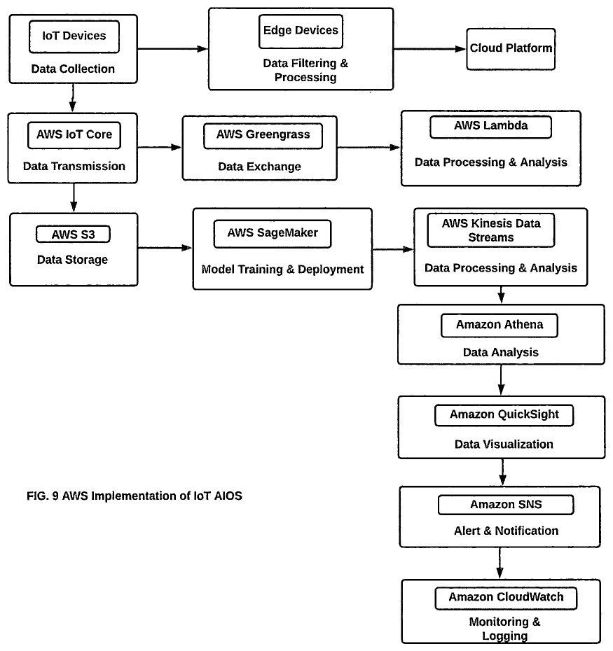

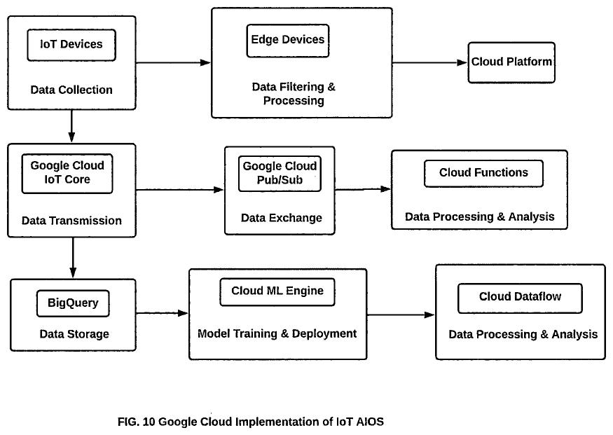

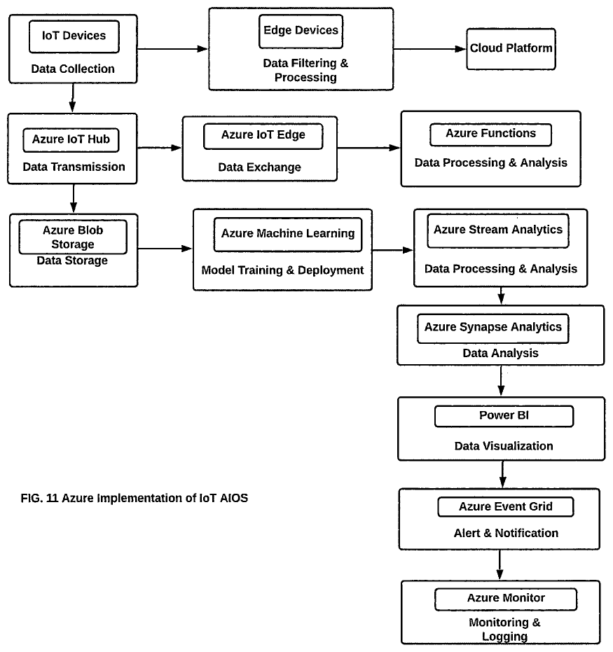

I claim:

1. The Smart Restaurant System is comprised of:
A. The Smart Kitchen
B. The Chef's App
C. The Smart Restaurant OS
D. The Ordering System
E. The Vending System
F. The Security System

2. The Smart Restaurant System, as described in claim 1, includes an AI-based OS, referred to as AIOS, for the Smart Restaurant OS specified in claim 1.C.

3. The Smart Restaurant System, as described in claims 1 to 2, includes a Cloud Native OS for the Smart Restaurant OS specified in claim 1.C.

4. The Smart Restaurant System, as described in claims 1 to 3, includes a Chef's App, specified in claim 1.B, which allows the restaurant operator to control and monitor the Smart Restaurant through communication with the Smart Restaurant Cloud Native IoT AIOS using MQTT.

5. The Smart Restaurant System, as described in claims 1 to 4, includes an emergency switch that serves as a backup mechanism for promptly shutting down or activating the entire Smart Restaurant or individual kitchen appliances or systems in an emergency. The operator can trigger the switch using the Chef's App, which sends a request to the Cloud-Native IoT AI Operating System (AIOS). The AIOS then turns off or on the entire restaurant or the designated kitchen appliances or systems, providing efficient control during unforeseen circumstances such as power outages or equipment malfunctions.

6. The Smart Restaurant System as described in any one of claims 1 to 5 comprises the Smart Kitchen of claim 1.A, which includes IoT kitchen appliances, an IoT Base Transport System, a Temperature Controlled IoT Storage System and Freezers, and an IoT Ready to Vend System.

7. The Smart Restaurant System, as described in claims 1 to 6, comprises the Smart Kitchen as described in claim 6, in which each system or kitchen appliance has an IoT station that utilizes tiny automated vehicles, commonly referred to as “cars,” to transport packages to designated destinations.

8. The Smart Restaurant System, as described in claims 1 to 7, includes the Smart Kitchen, as described in claims 6 and 7, that is equipped with the Base Transport System that covers the floor of the kitchen, with all appliances and systems mounted on top. This Base Transport System connects with the Temperature Controlled IoT Storage System and Freezers, as well as the IoT Ready to Vend System.

9. The Smart Restaurant System, as outlined in claims 1 to 8, includes a Smart Kitchen, of any one of the claims 6 to 8, which features a Base Transport System that serves as the foundation for the movement of small automated vehicles, referred to as “cars,” to transport packages to designated destinations. It is designed to function in conjunction with the IoT stations and the Smart Restaurant AIOS, which provides commands for the vehicle's movement and oversees and regulates package transportation. This combination of the Base Transport System, IoT stations, and Smart Restaurant AIOS results in an integrated and efficient solution for package transportation within the Smart Kitchen and Smart Restaurant.

10. The Smart Restaurant System, as described in claims 1 to 9, further comprises a Smart Kitchen, of any one of the claims 6 to 8, which includes a common station that utilizes small automated vehicles, referred to as “cars,” for the transportation of packages to designated destinations. The “cars” are integrated into the common station, allowing for optimized package transportation within the Smart Kitchen and Smart Restaurant.

11. The Smart Restaurant System, of any one of the claims 1 to 10, includes a Smart Kitchen, of any one of the claims 6 to 10, and the said Smart Kitchen further comprises zero or more Pizza Dough Prep Stack(s).
1. Each Pizza Dough Prep Stack comprises a Pizza Dough Station, a Pizza Dough Packager, and a Pizza Dough Maker.
2. The Pizza Dough Station is at the bottom of the stack and is mounted on top of the Base Transport System.
3. The Pizza Dough Packager is on top of the Pizza Dough Station.
4. The Pizza Dough Maker is on top of the Pizza Dough Packager.
5. The Stack has lifts on its sides.

12. The Smart Restaurant System, of any one of the claims 1 to 11, includes a Smart Kitchen, of any one of the claims 6 to 11, and the said Smart Kitchen further comprises zero or more Pizza Crust Prep Stack(s).
1. Each Pizza Crust Prep Stack comprises a Pizza Crust Station, a Pizza Crust Packager, and a Pizza Crust Maker.
2. The Pizza Crust Station is at the bottom of the stack and is mounted on top of the Base Transport System.
3. The Pizza Crust Packager is on top of the Pizza Crust Station.
4. The Pizza Crust Maker is on top of the Pizza Crust Packager.
5. The Stack has lifts on its sides.

13. The Smart Restaurant System, of any one of the claims 1 to 12, includes a Smart Kitchen, of any one of the claims 6 to 12, and the said Smart Kitchen further comprises zero or more Pizza Stack(s).
1. Each Pizza Stack comprises a Pizza Station, a Pizza Packager, and a Pizza Maker.
2. The Pizza Station is at the bottom of the stack and is mounted on top of the Base Transport System.
3. The Pizza Packager is on top of the Pizza Station.
4. The Pizza Maker is on top of the Pizza Packager.
5. The Pizza Maker comprises a Toppings Sprayer.
6. The Stack has lifts on its sides.

14. The Smart Restaurant System, of any one of the claims 1 to 13, includes a Smart Kitchen, of any one of the claims 6 to 13, and the said Smart Kitchen further comprises zero or more Fruit Slicer Stack(s).
1. Each Fruit Slicer Stack comprises a Fruit Slicer Station, a Fruit Slice Packager, and a Fruit Slicer.
2. The Fruit Slicer Station is at the bottom of the stack and is mounted on top of the Base Transport System.
3. The Fruit Slice Packager is on top of the Fruit Slicer Station.
4. The Fruit Slicer is on top of the Fruit Slice Packager.
5. The Stack has lifts on its sides.

15. The Smart Restaurant System, of any one of the claims 1 to 14, includes a Smart Kitchen, of any one of the claims 6 to 14, and the said Smart Kitchen further comprises zero or more Juice Stack(s).
1. Each Juice Stack comprises a Juice Station, a Juice Packager, and a Juice Maker.
2. The Juice Station is at the bottom of the stack and is mounted on top of the Base Transport System.
3. The Juice Packager is on top of the Juice Station.
4. The Juice Maker is on top of the Juice Packager.
5. The Stack has lifts on its sides.

16. The Smart Restaurant System, of any one of the claims 1 to 15, includes a Smart Kitchen, of any one of the claims 6 to 15, and the said Smart Kitchen further comprises zero or more Pancake Stack(s).
1. Each Pancake Stack comprises a Pancake Station, a Pancake Packager, and a Pancake Maker.
2. The Pancake Station is at the bottom of the stack and is mounted on top of the Base Transport System.
3. The Pancake Packager is on top of the Pancake Station.
4. The Pancake Maker is on top of the Pancake Packager.
5. The Stack has lifts on its sides.

17. The Smart Restaurant System, of any one of the claims 1 to 16, includes a Smart Kitchen, of any one of the claims 6 to 16, and the said Smart Kitchen further comprises optional appliances such as Baking Ovens, Grills, Cake Makers, Cake Decorators, Pasta Dough Makers, Pasta Makers, Vegetable Cutters, Sauce Makers, Blenders, and Steamers, Salad Makers, Omelette Makers all mounted on the Base Transport System (as defined by claims 8 to 10).

18. The Smart Restaurant System, outlined in claims 1 to 17, includes a Smart Kitchen, of any one of the claims 6 to 17, and the said Smart Kitchen further comprises a Ready To Vend system connected to the Base Transport System (as defined by claims 9 and 10) with storage units (such as shelves) for ready to vend items.

19. The Smart Restaurant System of any one of the claims 1 to 18 wherein the said Smart Restaurant System further comprising of
19.a) zero or more smart garden comprising garden growing plants without human intervention using robots.

20. The Smart Restaurant System of any one of the claims 1 to 19 wherein the said smart garden of claim 19.a, further comprising
20.a) zero or more IoT plants processing station wherein the plants are cleaned, cut, packaged and transported to the storage unit. The Chef's App can be used by the restaurant operator to control and monitor the Smart Garden and the IoT plants processing station through communication with the Smart Restaurant Cloud Native IoT AIOS using MQTT.
